(19) United States
(12) Patent Application Publication
(10) Pub. No.: US 2026/0099743 A1
(43) Pub. Date: Apr. 9, 2026

(54) Systems And Methods for Optimizing Parameterized Quantum Circuits for Combinatorial Optimization and Machine Learning Tasks Using Coordinate-Descent

(71) Applicant: JPMORGAN CHASE BANK, N.A., New York, NY (US)

(72) Inventors: Rudy Raymond Harry PUTRA, Manhattan, NY (US); Pradeep NIROULA, College Park, MD (US); Alexander BUTS, Jersey City, NJ (US); Marco PISTOIA, Amawalk, NY (US)

(21) Appl. No.: 18/904,769

(22) Filed: Oct. 2, 2024

(51) Int. Cl. G06N 10/20

(52) U.S. Cl. CPC G06N 10/20

(57) ABSTRACT

Systems and methods for optimizing parameterized quantum circuits for combinatorial optimization and machine learning tasks using coordinate-descent are disclosed. A classical computer program constructs a plurality of parameterized quantum circuits with quantum circuit for an objective function and selects Pauli operators associated with decision variables. The classical computer program sends the parameterized quantum circuits and Pauli operators to a quantum computer, which executes the circuits and measures the decision variables. The classical computer program receives the measurements, calculates an objective value, and determines if a stopping criterion is met. If the stopping criterion is not met, the classical computer program selects a parameter, instructs the quantum computer to execute the circuits with the selected parameter, and computes an optimized value. The process repeats until the stopping criterion is met, and the objective value is outputted.

### BACKGROUND OF THE INVENTION

### 1. Field of the Invention

Embodiments relate to systems and methods for using coordinate descent for optimizing quantum circuits built from quantum gates with parameters for combinatorial optimization and machine learning tasks.

### 2. Description of the Related Art

Quantum computers are commonly used to solve complex optimization problems. Even though they are well-suited for this task, there are still known issues with using quantum computers for optimization tasks. For example, the size of the device (e.g., the number of qubits and quantum gates) needed to solve an optimization problem scales with the number of decision variables one is optimizing for. That is, with the Quantum Approximate Optimization Algorithm (QAOA) or other optimization methods, a qubit is needed to encode each decision variable (i.e., n decision variables=n qubits). This effectively limits the size of the instances of optimization can be solved with available quantum computers.

In addition, popular quantum optimization techniques use “gradients” of a loss function to find an optimal solution. Gradient-based techniques, however, suffer from at least two limitations. First, there exists a known problem of barren plateaus, where the magnitude of gradient vanishes (i.e., goes to zero) as the number of qubits and quantum gates grows, making it hard to train parameters of the quantum circuits efficiently. Secondly, many gradient-based methods were originated from optimizing classical models whose cost of evaluating gradients is negligible while applying them to quantum circuits can be impractical because each gradient update requires evaluating partial derivatives that scale with the number of quantum gates, and hence the difficulty in training parameters.

Further, current methods for quantum optimization use a feedback loop where the quantum computer is probed at every step. Such a loop is susceptible to network latency and limited quantum device availability.

### SUMMARY OF THE INVENTION

Systems and methods for using coordinate descent for optimizing quantum circuits built from quantum gates with parameters for combinatorial optimization and machine learning tasks are disclosed. According to an embodiment, a method may include: (1) receiving, by a classical computer program executed by a client electronic device, an optimization problem comprising an objective function; (2) constructing, by the classical computer program, a plurality of parameterized quantum circuits for the objective function; (3) selecting, by the classical computer program, a plurality of Pauli operators, wherein each Pauli operator may be associated with an assignment variable; (4) sending, by the classical computer program, the plurality of parameterized quantum circuits and the plurality of Pauli operators to a quantum computer; (5) receiving, by the classical computer program and from the quantum computer, measurements of the assignment variables measured with the Pauli operators, wherein the Pauli operators measure a quantum state of quantum computer following execution of the parameterized quantum circuits; (6) converting, by the classical computer program, the assignment variables to decision variables, wherein the decision variables have binary values; (7) calculating, by the classical computer program, an objective value based on the measurements; (8) determining, by the classical computer program, that a stopping criterion is met; and (9) outputting, by the classical computer program, the objective value.

In one embodiment, the stopping criterion may be time-based, may be based on a number of iterations, may be based on a target objective value being met, etc.

In one embodiment, in response to the stopping criterion not being met, the method may also include: selecting, by the classical computer program, one of the plurality of quantum circuits; selecting, by the classical computer program, a parameter index; instructing, by the classical computer program, the quantum computer to execute the parameterized quantum circuits with the selected parameter and parameter index, and to measure the Pauli operators; receiving, by the classical computer program, measurements of the assignment variables measured with the Pauli operators from the quantum computer; converting, by the classical computer program, the assignment variables to the decision variables, wherein the decision variables have binary values; computing, by the classical computer program, an optimized value for the selected parameter; and repeating, the step of determining, by the classical computer program, that the stopping criterion is met.

In one embodiment, n qubits of the quantum computer represent up to 4ⁿ⁻¹ Pauli operators.

In one embodiment, the objective function comprises a binary optimization problem.

In one embodiment, the assignment variables identify a quantum state of the plurality of parameterized quantum circuits.

According to another embodiment, a system may include: a client electronic device executing a classical computer program; and a quantum computer. The classical computer program receives an optimization problem comprising an objective function, constructs a plurality of parameterized quantum circuits for the objective function, selects a plurality of Pauli operators, wherein each Pauli operator may be associated with an assignment variable, and sends the plurality of parameterized quantum circuits and the plurality of Pauli operators to a quantum computer. The quantum computer executes the plurality of parameterized quantum circuits. The classical computer program receives, from the quantum computer, measurements of the assignment variables measured with the Pauli operators, wherein the Pauli operators measure a quantum state of quantum computer following execution of the parameterized quantum circuits, converts the assignment variables to decision variables, wherein the decision variables have binary values, calculates an objective value based on the measurements, determines that a stopping criterion is met; and outputs the objective value.

In one embodiment, the stopping criterion may be time-based, may be based on a number of iterations, may be based on a target objective value being met, etc.

In one embodiment, in response to the stopping criterion not being met, the classical computer program selects one of the plurality of quantum circuits; the classical computer program selects a parameter index; the classical computer program instructs the quantum computer to execute the parameterized quantum circuits with the selected parameter and parameter index, and to measure the Pauli operators; the classical computer program receives measurements of the assignment variables measured with the Pauli operators from the quantum computer; the classical computer program converts the assignment variables to the decision variables, wherein the decision variables have binary values; the classical computer program computes an optimized value for the selected parameter; and the classical computer program repeats determining that the stopping criterion is met.

In one embodiment, n qubits of the quantum computer represent up to 4ⁿ⁻¹ Pauli operators.

In one embodiment, the objective function comprises a binary optimization problem.

In one embodiment, the decision variables identify a quantum state of the plurality of parameterized quantum circuits.

According to another embodiment, a non-transitory computer readable storage medium, including instructions stored thereon, which when read and executed by one or more computer processors, cause the one or more computer processors to perform steps comprising: receiving an optimization problem comprising an objective function; constructing a plurality of parameterized quantum circuits for the objective function; selecting a plurality of Pauli operators, wherein each Pauli operator may be associated with an assignment variable; sending the plurality of parameterized quantum circuits and the plurality of Pauli operators to a quantum computer; receiving, from the quantum computer, measurements of the assignment variables measured with the Pauli operators, wherein the Pauli operators measure a quantum state of quantum computer following execution of the parameterized quantum circuits; converting the assignment variables to decision variables, wherein the decision variables have binary values; calculating an objective value based on the measurements; determining that a stopping criterion is met; and outputting the objective value.

In one embodiment, the stopping criterion may be time based, may be based on a number of iterations, may be based on a target objective value being met, etc.

In one embodiment, n qubits of the quantum computer represent up to 4ⁿ⁻¹ Pauli operators.

In one embodiment, the non-transitory computer readable storage medium may also include instructions stored thereon, which, in response to the stopping criterion not being met, when read and executed by the one or more computer processors, cause the one or more computer processors to perform steps comprising: selecting one of the plurality of quantum circuits; selecting a parameter index value; instructing the quantum computer to execute the parameterized quantum circuits with the selected parameter and parameter index value, and to measure the Pauli operators; receiving measurements of assignment variables measured with the Pauli operators from the quantum computer; converting the assignment variables to decision variables, wherein the decision variables have binary values; computing an optimized value for the selected parameter; and repeating the step of determining that the stopping criterion is met.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for optimizing parameterized quantum circuits for combinatorial optimization and machine learning tasks using coordinate-descent according to an embodiment;

FIG. 2 illustrates a method for optimizing parameterized quantum circuits for combinatorial optimization and machine learning tasks using coordinate-descent according to an embodiment; and

FIG. 3 depicts an exemplary computing system for implementing aspects of the present disclosure.

### DETAILED DESCRIPTION OF PREFERRED EMBODIMENTS

Embodiments relate to systems and methods for optimizing parameterized quantum circuits for combinatorial optimization and machine learning tasks using coordinate-descent.

Embodiments may sporadically probe the quantum machine and may perform a majority of the optimization without a quantum computer.

Embodiment may enable optimization over a much larger number of decision variables than using traditional techniques. For example, traditional coordinate-descent methods, such as Rotosolve (e.g., Ostaszewski, et al. “Structure optimization for parameterized quantum circuits” Quantum, 5:391 (2021)), Fraxis (e.g., Watanabe, et al. “Optimizing parameterized quantum circuits with free-axis single-qubit gates” IEEE Transactions on Quantum Engineering, 4:1-16 (2023), and FQS (e.g., Wada, et al. “Sequential optimal selections of single-qubit gates in parameterized quantum circuits” (2023), available at doi.org/10.21203/rs.3.rs-2862066/v1) are only for conventional cost/loss function encoding one decision variable per qubit or can be only at most three times the number of qubits by using the quantum relaxation (e.g., U.S. Patent Application Publication No. 2023/0133198). The disclosure of each of these documents is hereby incorporated, by reference, in its entirety.

Embodiments may provide larger-than-three constant, poly, or even exponential scaling in the number of qubits used for representing decision variables required to solve larger scale of problems. For example, a quantum device with 20 qubits may be used to find solutions for certain optimization problems having over 800 decision variables.

Because embodiments are gradient-free, embodiments may be applied on quantum devices that do not allow analytical gradient evaluation. A single update of parameter is guaranteed to improve the cost/loss function and can be done with only two (or a constant number of) circuit evaluations on average. In general, gradient-based methods require O(m) circuit evaluations for m parameters, while traditional gradient-free methods may suffer from the pitfalls of barren-plateaus or do not guarantee improvements per parameter updates.

Embodiments may offload much of the parameter optimization to a classical computer executing a classical computer program. Thus, embodiments are not limited by network latency and device availability. This allows for training and using quantum devices with better efficiency.

By receiving an optimization problem comprising an objective function, the classical computer program can systematically approach complex optimization tasks, ensuring that the problem is well-defined and ready for quantum processing.

Constructing a plurality of parameterized quantum circuits with a plurality of quantum circuit for the objective function allows the system to explore a wide range of potential solutions, leveraging the inherent parallelism of quantum computing to handle multiple decision variables simultaneously.

Selecting a plurality of Pauli operators, each associated with a decision variable, enables efficient encoding and measurement of quantum states. This association allows the system to utilize a smaller number of qubits to represent a larger number of decision variables, significantly enhancing the scalability of the quantum optimization process.

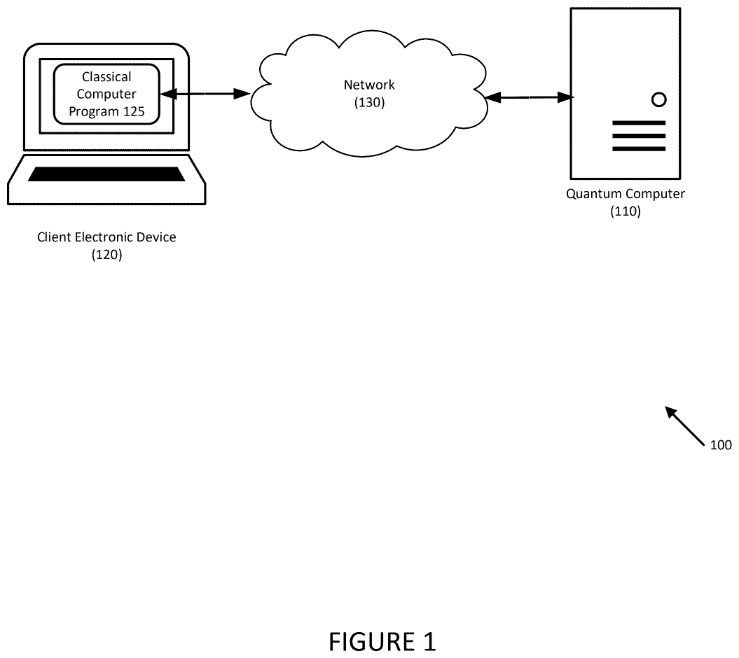

Referring to FIG. 1, a system for optimizing parameterized quantum circuits for combinatorial optimization and machine learning tasks using coordinate-descent is disclosed according to an embodiment. System 100 may include quantum computer 110 that may execute parameterized quantum circuit. A quantum circuit is a model for quantum computation that may include a sequence of quantum gates, measurements, initializations of qubits to known values, etc.

Quantum computer 110 may be a device that performs quantum computations, such as those based on the collective properties of the quantum state for a quantum system. A quantum system is a system that allows quantum computers or devices to perform their computation according to the principles of quantum mechanics. Quantum states are the intermediate and final outputs of quantum computers when performing computation in the quantum systems. A quantum state has unique properties not observed in classical states; they are quantum superposition, interference, and entanglement.

Client electronic device 120 may be any suitable general purpose computing device, including servers, workstations, desktops, notebooks, laptops, tablet computers, smart devices (e.g., smart phones, smart watches, etc.), Internet of Things (IoT) appliances, etc. For example, client electronic device 120 may be a microprocessor-based device. Client electronic device 120 may interface with quantum computer 110 using classical computer program 125, which may provide input to, and receive output from, quantum computer 110. In one embodiment, classical computer program 125 may generate the parameterized quantum circuits, may transpile the parameterized quantum circuits to machine-readable instructions, and may then send the transpiled circuit(s) over network 130 to quantum computer 110 for execution. Classical computer program 125 may also receive the results of the execution of the parameterized quantum circuits from quantum computer 110 also over network 130.

Classical computer program 125 may also determine, based on the output of the quantum computer, whether a stopping criterion is met. If the stopping criterion is not met, the classical computer program may instruct the quantum computer to select a parameter and optimize it.

In one embodiment, network 130 may be a public network such as the Internet.

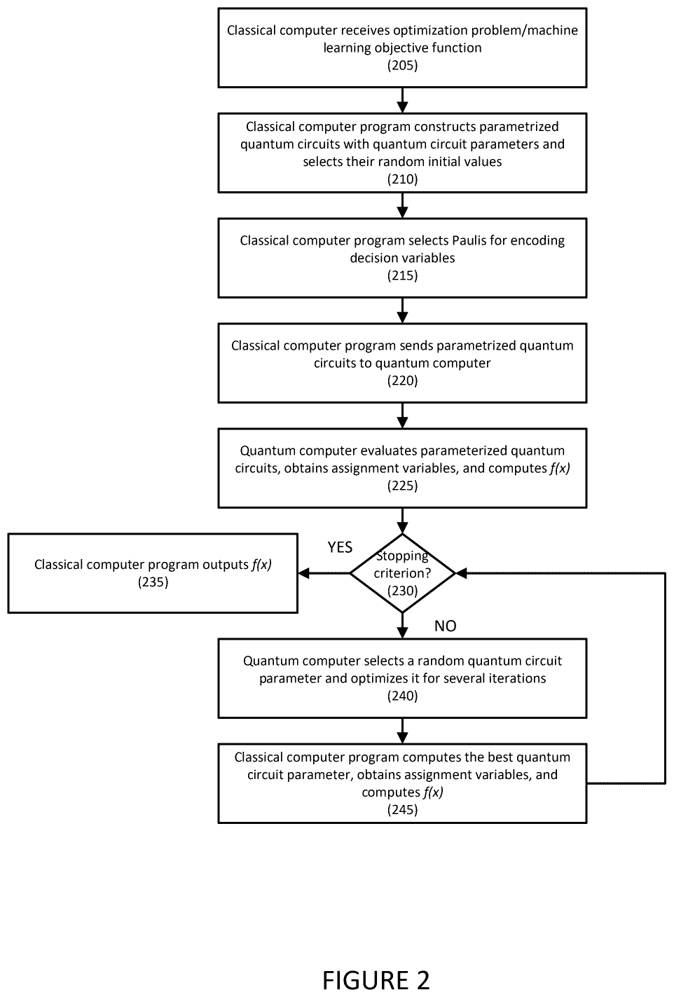

Referring to FIG. 2, a method for optimizing parameterized quantum circuits for combinatorial optimization and machine learning tasks using coordinate-descent is disclosed according to an embodiment.

In step 205, a classical computer program executed by a client electronic device may receive an optimization problem or machine learning objective function, f(x). An optimization problem is a mathematical problem that involves finding the best solution from a set of feasible solutions. The “best” solution is typically defined in terms of maximizing or minimizing an objective function, which quantifies the goal of the problem. An example of such an optimization problem is a binary optimization problem, such as the MaxCut problem (e.g., described in Goemans and Williamson, “Improved approximation algorithms for maximum cut and satisfiability problems using semidefinite programming” (1995), available at //doi.org/10.1145/227683.227684, the disclosure of which is hereby incorporated, by reference, in its entirety).

The output of the objective function, x, is the objective value. The objective function is the value of x on the function f, namely, f(x). The objective value f(x) represents the function to be optimized. As an illustrative example, for financial tasks, x can be a portfolio and f(x) is the value of the portfolio, or the risk of the portfolio, etc.

For example, the optimization problem may be described in standard text-based format. A popular format is the LP format supported by CPLEX and Gurobi, two popular optimization solvers. In general, the LP format defines the objective function, the decision variables, and the constraints of the optimization problems. Optimization programs may use the LP format to run their algorithms to solve the problems.

The optimization problem includes an objective function. The objective function is a mathematical expression that needs to be maximized or minimized. It is a function of decision variables, which are variables that can be controlled or adjusted to optimize the objective function. The decision variables are determined by the quantum states produced by the quantum circuits which are controlled by their parameters.

Decision variables x₁, . . . , xₖ, . . . xₙ represent decisions that are used to solve the optimization problem. For example, when decision variables x₁, . . . , xₖ, . . . xₙ are binary variables (e.g., YES/NO), they represent decisions to perform (YES) or not perform (NO) certain actions. As another example, if the decision variables represent the ratio of stocks in a portfolio optimization, each decision variable may represent a ratio of stock/asset in the optimal portfolio.

The decision variables may be based on the assignment variables that are a result of measuring the quantum states in the Pauli basis. For example, the assignment variables may have a range of −1 to 1. The assignment variables may be converted to binary decision variables based on the signs of the assignment variables.

The objective function can take various forms depending on the specific problem being addressed. For example, in a binary optimization problem, the objective function might be to maximize or minimize a certain value, such as profit, cost, or risk, based on the configuration of the decision variables.

In step 210, the classical computer program may construct a plurality of parameterized quantum circuits for the optimization problem or machine learning objective function with quantum circuit parameters θ₁, . . . , θₖ, . . . , θₘ, and may select their random initial values. The number of quantum circuit parameters may be set by the user as part of the product definition.

For example, the classical computer program may generate quantum circuits that consist of a sequence of quantum gates and measurements from the optimization problem (e.g., in the LP format).

The quantum circuit parameters may produce a quantum state, and the objective function is a function of measurements performed on the quantum state.

In step 215, the classical computer program may select Pauli operators, which are a specific set of quantum gates, for encoding and measuring decision variables x₁, . . . , xₖ, . . . xₙ. Pauli operators are used for Pauli measurements, which generalize computational basis measurements to include measurements in other bases.

Each Pauli operator may be associated with one of the assignment variables. This enables the use of just a few qubits to encode a large number of assignment variables because n qubits can represent up to 4ⁿ−1 different Pauli operators.

The Pauli operators determine the corresponding measurements for the assignment variables. For example, the quantum state, ρ(θ), may be measured with the Pauli operators to determine the assignment variables. At the same time, the assignment variables and the measurements to be performed to the quantum state may be selected.

In step 220, the classical computer may send the parameterized quantum circuits, the quantum circuit parameters, and the Pauli operators to a quantum computer over a network, such as the Internet. The Pauli operators may be used to determine how the quantum circuit is measured by appending small circuits/single-qubit gates before measurements in the computational bases.

In step 225, the quantum computer may execute the parameterized quantum circuits with quantum circuit parameters θ₁, . . . , θₖ, . . . , θₘ, may obtain decision variables xᵢ≡<Pᵢρ(θ)>¿ᵢ by measuring the quantum state using the Pauli operators, and may and compute the objective function, f(x). The quantum circuit may be run multiple times, and the number of times it is run may be a parameter that may be set by the user.

In one embodiment, if xᵢ are binaries, xᵢ=sign(<Pᵢρ(θ)>), where sign() takes the sign of its argument.

The Pauli operators may not only be used to measure the quantum state but may also be used to construct the quantum circuit. The expectation value, ¿ρ(θ)>¿, may include a set of real values, x, that can be considered without loss of generality lie between −1 and 1.

In one embodiment, a set of values may be returned for each parameterized quantum circuit. For example, different set of values are returned for each quantum circuit because the same set of quantum circuit can produce different set of values due to statistical deviations, and because different sets of quantum circuit can produce different values.

In step 230, the classical computer program may receive the measurements of the assignment variables from the quantum computer over the network. It may then convert the assignment variables into binary decision variables based on the sign of each assignment variable. It may then calculate the objective value based on the measurements using argmaxf(x)=x^{t}Qx+bx+c. x, which is obtained by argmax, is the vector of decision variables x₁, . . . , xₖ, . . . xₙ to achieve the objective value.

f(x) is the value of x, the objective value. In one embodiment, the objective value may be calculated for each set of values. Using the objective value that is best for the problem, the classical computer program may determine if a stopping criterion is met. For example, the classical computer program may receive the result of measurements of the output of quantum state ρ(θ) according to the Pauli operators, and the stopping criterion may be a time limitation (e.g., a number of hours of computation), a number of iterations without a change in the objective value, a target objective value of optimization being met, etc.

As an illustrative example, assuming that x is a financial portfolio, and f(x) is the risk of x to be minimized. A user can set a target value of f(x) to be 10 basis points (or, 0.0010). The iteration can be halted/ended when the algorithm finds an x that has a f(x) is less than 10 basis points (although it may find smaller values by having more iterations).

In one embodiment, for a minimization problem (e.g., cost, risk, etc.), the smallest objective value may be selected; for a maximization (e.g., for profits, returns, etc.), the largest objective value may be selected.

In one embodiment, to determine if the target objective value is met, the classical computer program may aggregate the objective values from the measurements of the quantum circuits.

In one embodiment, the target objective value may be set by the user as part of the problem definition.

In one embodiment, if the objective value is better than a target objective value, no further measurements may be made. In another embodiment, if a time limit is met (e.g., a time set by the user), no further measurements may be made.

If the stopping criterion is met, in step 235, the classical computer program may output the objective value(s).

If the stopping criterion is not met, in step 240, the quantum computer may select a quantum circuit parameter θⱼ∈(θ₁, . . . , θₘ) at random and may optimize the selected quantum circuit parameter by evaluating its S^{[i, j]} matrices for i=1, . . . , n. In one embodiment, the quantum computer may be instructed by the classical computer program, to select which parameter index is to be optimized. The classical computer program may select the parameter index randomly, sequentially, etc.

In one embedment, the S^{[i, j]} matrices for i=1, . . . , n are matrices used to determine the optimal value of the j-th parameter of the quantum circuit, which is the quantum circuit parameter θⱼ.

For example, the classical computer program may select an index, and the quantum computer may execute the quantum circuits and measure the Pauli operators. From those measurements, the classical computer program may calculate the objective value and optimize the objective value.

In step 245, the classical computer program may compute an optimized value for quantum circuit parameter θⱼ, which is the value that gives the lowest objective value, obtains assignment variables xᵢ≡<Pᵢρ(θ)>¿ᵢ, converts them to binary decision variables based on their signs, and computes the objective value f(x), resulting in values for the decision variables x₁, . . . , xₖ, . . . xₙ. In one embodiment, each indexed quantum circuit parameter θᵢ may be optimized separately by the classical computer program.

The optimal value for a quantum circuit parameter θⱼ may be computed by gathering experimental data from running the quantum circuits, e.g., by replacing the corresponding gate with a set of basis gates, executing and measuring the corresponding circuits, and recording the measurement results for post-processing with classical device.

For example, having the experimental data from the quantum computer, the classical computer may compute the optimized value for a quantum circuit parameter θⱼ without requiring execution by the quantum computer. The optimized quantum circuit parameter θⱼ is guaranteed to obtain better objective values. The classical computer can then evaluate the best value for the objective function f(x) and the matrix of decision variables x that corresponds to the solution of the underlying optimization or machine learning task.

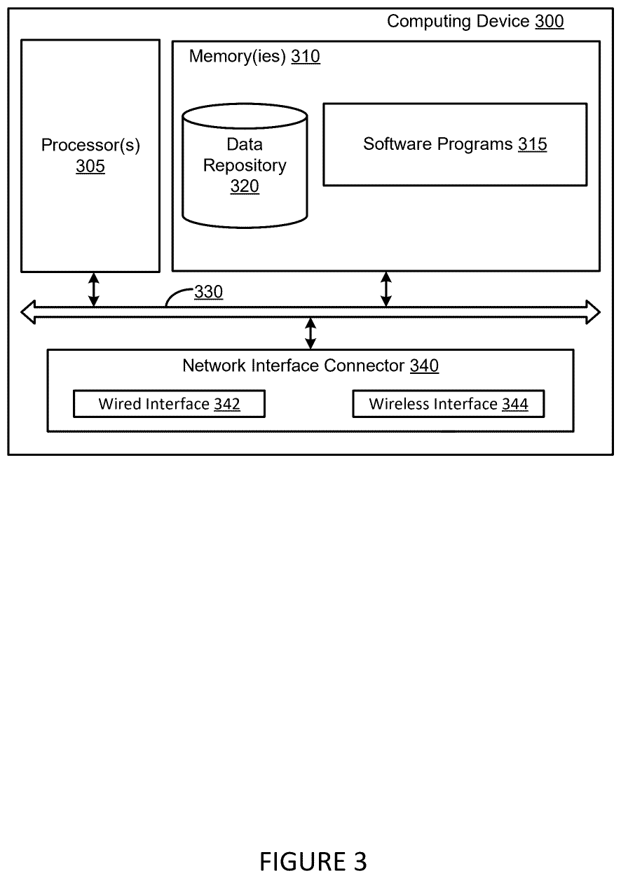

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

The disclosure of U.S. patent application Ser. No. 18/625,633 is hereby incorporated, by reference, in its entirety.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a classical computer program executed by a client electronic device, an optimization problem comprising an objective function;
constructing, by the classical computer program, a plurality of parameterized quantum circuits for the objective function;
selecting, by the classical computer program, a plurality of Pauli operators, wherein each Pauli operator is associated with an assignment variable;
sending, by the classical computer program, the plurality of parameterized quantum circuits and the plurality of Pauli operators to a quantum computer;
receiving, by the classical computer program and from the quantum computer, measurements of the assignment variables measured with the Pauli operators, wherein the Pauli operators measure a quantum state of quantum computer following execution of the parameterized quantum circuits;
converting, by the classical computer program, the assignment variables to decision variables, wherein the decision variables have binary values;
calculating, by the classical computer program, an objective value based on the measurements;
determining, by the classical computer program, that a stopping criterion is met; and
outputting, by the classical computer program, the objective value.

2. The method of claim 1, wherein the stopping criterion is time-based.

3. The method of claim 1, wherein the stopping criterion is based on a number of iterations.

4. The method of claim 1, wherein the stopping criterion is based on a target objective value being met.

5. The method of claim 1, further comprising:
in response to the stopping criterion not being met:
selecting, by the classical computer program, one of the plurality of quantum circuits;
selecting, by the classical computer program, a parameter index;
instructing, by the classical computer program, the quantum computer to execute the parameterized quantum circuits with the selected parameter and parameter index, and to measure the Pauli operators;
receiving, by the classical computer program, measurements of the assignment variables measured with the Pauli operators from the quantum computer;
converting, by the classical computer program, the assignment variables to the decision variables, wherein the decision variables have binary values;
computing, by the classical computer program, an optimized value for the selected parameter; and
repeating, the step of determining, by the classical computer program, that the stopping criterion is met.

6. The method of claim 1, wherein n qubits of the quantum computer represent up to 4ⁿ⁻¹ Pauli operators.

7. The method of claim 1, wherein the objective function may include a binary optimization problem.

8. The method of claim 1, wherein the assignment variables identify a quantum state of the plurality of parameterized quantum circuits.

9. A system, comprising:
a client electronic device executing a classical computer program; and
a quantum computer;
wherein:
the classical computer program receives an optimization problem comprising an objective function;
the classical computer program constructs a plurality of parameterized quantum circuits for the objective function;
the classical computer program selects a plurality of Pauli operators, wherein each Pauli operator is associated with an assignment variable;
the classical computer program sends the plurality of parameterized quantum circuits and the plurality of Pauli operators to a quantum computer;
the quantum computer executes the plurality of parameterized quantum circuits;
the classical computer program receives, from the quantum computer, measurements of the assignment variables measured with the Pauli operators, wherein the Pauli operators measure a quantum state of quantum computer following execution of the parameterized quantum circuits;
the classical computer program converts the assignment variables to decision variables, wherein the decision variables have binary values;
the classical computer program calculates an objective value based on the measurements;
the classical computer program determines that a stopping criterion is met; and
the classical computer program outputs the objective value.

10. The system of claim 9, wherein the stopping criterion is time-based.

11. The system of claim 9, wherein the stopping criterion is based on a number of iterations.

12. The system of claim 9, wherein the stopping criterion is based on a target objective value being met.

13. The system of claim 9, further comprising:
in response to the stopping criterion not being met:
the classical computer program selects one of the plurality of quantum circuits;
the classical computer program selects a parameter index;
the classical computer program instructs the quantum computer to execute the parameterized quantum circuits with the selected parameter and parameter index, and to measure the Pauli operators;
the classical computer program receives measurements of the assignment variables measured with the Pauli operators from the quantum computer;
the classical computer program converts the assignment variables to the decision variables, wherein the decision variables have binary values;
the classical computer program computes an optimized value for the selected parameter; and
the classical computer program repeats determining that the stopping criterion is met.

14. The system of claim 9, wherein n qubits of the quantum computer represent up to 4ⁿ⁻¹ Pauli operators.

15. The system of claim 9, wherein the objective function may include a binary optimization problem.

16. The system of claim 9, wherein the decision variables identify a quantum state of the plurality of parameterized quantum circuits.

17. A non-transitory computer readable storage medium, including instructions stored thereon, which when read and executed by one or more computer processors, cause the one or more computer processors to perform steps comprising:
receiving an optimization problem comprising an objective function;
constructing a plurality of parameterized quantum circuits for the objective function;
selecting a plurality of Pauli operators, wherein each Pauli operator is associated with an assignment variable;
sending the plurality of parameterized quantum circuits and the plurality of Pauli operators to a quantum computer;
receiving, from the quantum computer, measurements of the assignment variables measured with the Pauli operators, wherein the Pauli operators measure a quantum state of quantum computer following execution of the parameterized quantum circuits;
converting the assignment variables to decision variables, wherein the decision variables have binary values;
calculating an objective value based on the measurements;
determining that a stopping criterion is met; and
outputting the objective value.

18. The non-transitory computer readable storage medium of claim 17, wherein the stopping criterion is time based, is based on a number of iterations, or is based on a target objective value being met.

19. The non-transitory computer readable storage medium of claim 17, wherein n qubits of the quantum computer represent up to 4ⁿ⁻¹ Pauli operators.

20. The non-transitory computer readable storage medium of claim 17, further including instructions stored thereon, which when read and executed by the one or more computer processors, cause the one or more computer processors to perform steps comprising:
in response to the stopping criterion not being met:
selecting one of the plurality of quantum circuits;
selecting a parameter index value;
instructing the quantum computer to execute the parameterized quantum circuits with the selected parameter and parameter index value, and to measure the Pauli operators;
receiving measurements of assignment variables measured with the Pauli operators from the quantum computer;
converting the assignment variables to decision variables, wherein the decision variables have binary values;
computing an optimized value for the selected parameter; and
repeating the step of determining that the stopping criterion is met.
